(19) United States
(12) Patent Application Publication
(10) Pub. No.: US 2024/0378012 A1
(43) Pub. Date: Nov. 14, 2024

(54) Audio Synchronization for Truly Wireless Wearables

(71) Applicant: Google LLC, Mountain View, CA (US)

(72) Inventor: Shahabuddin Kakargola, Costa Mesa, CA (US)

(73) Assignee: Google LLC, Mountain View, CA (US)

(21) Appl. No.: 18/690,090

(22) PCT Filed: Sep. 21, 2021
(86) PCT No.: PCT/US2021/051278

§ 371 Date: Mar. 7, 2024

(51) Int. Cl. G06F 3/16

(52) U.S. Cl. CPC G06F 3/162

(57) ABSTRACT

The technology provides for an audio codec with an inter-IC sound (I2S) word-select (WS) detector. The I2S WS detector is configured to enable an I2S agent and DAC within the audio codec such that they begin processing data simultaneously. The I2S WS detector may monitor a word-select signal received by the I2S signal for a rising edge and after detecting the rising edge on the WS signal, the I2S WS detector may send an enable command to the I2S agent and the DAC immediately before the a subsequent rising edge of the WS signal.

### BACKGROUND

Traditional, wireless audio headsets typically include a pair of headphones connected via a wired connection. Audio output by the pair of headphones is generally controlled by a single inter-IC sound (I2S) agent and two digital-to-analog (DACs). Each DAC provides audio to one of the headphones. In this regard, the DACs receive respective digital audio signals from the I2S agent and output corresponding analog audio signals to the connected headphones for playback to a listener. To maintain the synchronized playback of the audio signals through the pair of headphones, both DACs may be started simultaneously by the I2S agent. By doing such, both DACs may begin processing the digital audio signals received from the I2S agent simultaneously, increasing the likelihood playback is synchronized.

Unlike traditional wireless audio headsets, where the headphones are connected via a wired connection, truly wireless earbuds are connected wirelessly. Thus, synchronizing audio playback between a pair of truly wireless earbuds presents many difficulties not found in traditional, wired headsets. For instance, an audio signal sent to each earbud from an audio source may arrive at each earbud at different times, as the distance, interference, etc., between each earbud and the audio source, may differ. Thus, one earbud may receive and subsequently begin playback of the audio before the other earbud. When the playback of audio is out of sync by 50 microseconds, or more or less, a user may experience an unpleasant listening experience.

Further, each truly wireless earbud includes componentry, including an I2S agent and a DAC. The DAC and I2S agent of one wireless earbud may not communicate with the DAC and I2S agent of the other wireless earbud. As such, synchronizing the DACs and I2S agents of wireless earbuds may be difficult, as there is no wired connection between the two DACs or the two I2S agents through which start-up and control signals can be provided. The inability to synchronize the DACs and I2S agents may result in the playback of audio by the earbuds being further out of sync.

### BRIEF SUMMARY

The present disclosure provides for minimizing or avoiding delays introduced by an audio codec during the processing and playback of audio samples. One aspect of the disclosure is directed to an audio codec comprising: an inter-IC sound (I2S) agent; a digital-to-analog converter (DAC); and an I2S word-select (WS) detector, the I2S WS detector configured to enable the I2S agent and the DAC, such that the DAC and the I2S agent begin processing data simultaneously.

In some instances, the I2S agent is configured to receive a clock signal, a WS signal, and the data from a wireless system, where the data includes one or more digital audio samples.

In some examples, the I2S agent includes an internal buffer, and the I2S agent is configured to temporarily store the one or more digital audio samples in the internal buffer of the I2S agent.

In some examples, the system further includes a a memory buffer, wherein the I2S agent is configured to transmit the one or more digital audio samples in the internal buffer of the I2S agent to the memory buffer. In some instances, the memory buffer is a circular buffer.

In some examples, the DAC includes an internal buffer, wherein, the DAC is configured to: receive or retrieve one or more of the digital audio samples from the memory buffer; and store the one or more of the digital audio samples into the internal buffer of the DAC.

In some instances, the DAC is configured to convert the one or more of the digital audio samples into analog signals; and output the analog signals to a speaker for playback.

In some instances, the system further includes a processor. In some instances, the processor is configured to initialize the I2S agent and the DAC.

In some examples, the processor is further configured to, after initializing the I2S agent and the DAC, initialize the I2S WS detector.

In some examples, the I2S WS detector is configured to, after initialization, monitor the WS signal for a rising edge. In some examples, the I2S WS detector is further configured to, after detecting the rising edge on the WS signal, send an enable command to the I2S agent and the DAC immediately before a subsequent rising edge of the WS signal.

In some instances, the I2S WS detector is further configured to, after detecting the rising edge on the WS signal, wait a first predetermined period of time; and send an enable command to the I2S agent after the first predetermined period of time.

In some examples, the I2S WS detector is further configured to, after detecting the rising edge on the WS signal, wait a second predetermined period of time; and send an enable command to the DAC after the second predetermined period of time.

Another aspect of the disclosure is directed to a method for controlling an audio codec, including an inter-IC sound (I2S) agent, a digital-to-analog converter (DAC), and an I2S word-select (WS) detector. The method may include initializing the I2S agent, the DAC, and the I2S WS detector; receiving, by the I2S agent, a clock signal and a WS signal from a wireless system; monitoring, by the I2S WS detector, after initialization, the WS signal for a rising edge; and after detecting the rising edge, transmitting, by the I2S WS detector, an enable command to the DAC and an enable command to the I2S agent prior to a next rising edge on the WS signal.

In some instances, the method may further include waiting, by the I2S WS detector, a first predetermined period of time after detecting the rising edge on the WS signal; and sending by the I2S WS detector, the enable command to the I2S agent after the first predetermined period of time.

In some examples, the method may further include waiting, by the I2S WS detector, a second predetermined period of time after detecting the rising edge on the WS signal; and sending, by the I2S WS detector, the enable command to the DAC after the second predetermined period of time.

In some examples, the method may further include receiving, by the I2S agent one or more digital audio samples from the wireless system.

In some examples, the method may further include converting, by the DAC, the one or more digital audio samples received by I2S agent into analog signals for playback.

In some examples, the I2S WS detector is initialized after the DAC and the I2S agent.

### BRIEF DESCRIPTION OF THE DRAWINGS

FIG. 1 illustrates example clocking diagrams 121 and 131 showing a start-up process for I2S agents and DACs of audio codec systems in accordance with aspects of the disclosure.

FIG. 2 is an illustration of audio processing performed by audio codecs in accordance with aspects of the disclosure.

FIG. 3 is a block diagram of an example system, including an example pair of earbuds in accordance with aspects of the disclosure.

FIG. 4 is a block diagram illustrating communication between an I2S controller and an I2S agent in accordance with aspects of the disclosure.

FIG. 5 is a block diagram of an example audio codecs in accordance with aspects of the disclosure.

FIG. 6 illustrates an example clocking diagram in accordance with aspects of the disclosure.

FIG. 7 illustrates another example clocking diagram in accordance with aspects of the disclosure.

FIG. 8 is a flowchart illustrating a method of controlling an audio codec according to aspects of the disclosure.

### DETAILED DESCRIPTION

### Overview

This technology relates to synchronizing audio playback through a pair of truly wireless (TWS) earbuds by minimizing the risk of an unknown delay being introduced by components within an audio codec system. In this regard, the audio codec system typically includes a DAC interface and an I2S agent. In instances where the DAC starts processing audio data before the I2S agent starts providing audio data to the DAC, an unknown delay in outputting audio to the speaker of the earbud may occur. This delay, commonly known as a device under test (DUT) delay, is the delay from the time an audio sample enters the I2S agent and is output to be played on the speaker of the TWS earbud. The technology described herein starts the I2S agent and DAC simultaneously to assure a fixed DUT delay. By fixing the DUT delay within the audio codec systems within each earbud of a pair of TWS earbuds, additional delays introduced by DUT delay variance are avoided while playing back audio through the TWS earbuds.

The audio codec system typically gets a command to enable the I2S agent and DAC from another component within the TWC earbud, such as a Bluetooth or wireless system, both referred to herein as “wireless system.” When the audio codec system receives the enable command, the software within the audio codec system enables both the DAC and the I2S agent. However, it is generally not possible for the software of the audio codec system to consistently start the I2S agent and DAC interfaces together at the same time. This is because, even after receiving an enable command, the I2S agent will not start until it receives a rising edge of an I2S Word-Select (WS) signal provided by an I2S controller, which is part of the wireless system. The rising edge of the WS signal indicates the beginning of the audio sample on the I2S data bus that connects the I2S controller and the I2S agent. However, when the software of the audio codec system enables the DAC interface, the DAC starts on the next I2S clock pulse provided by the I2S controller. As the I2S clock frequency is typically much higher than the frequency of the WS signal, the DAC will typically start processing audio samples before the I2S agent starts, causing an unknown DUT delay.

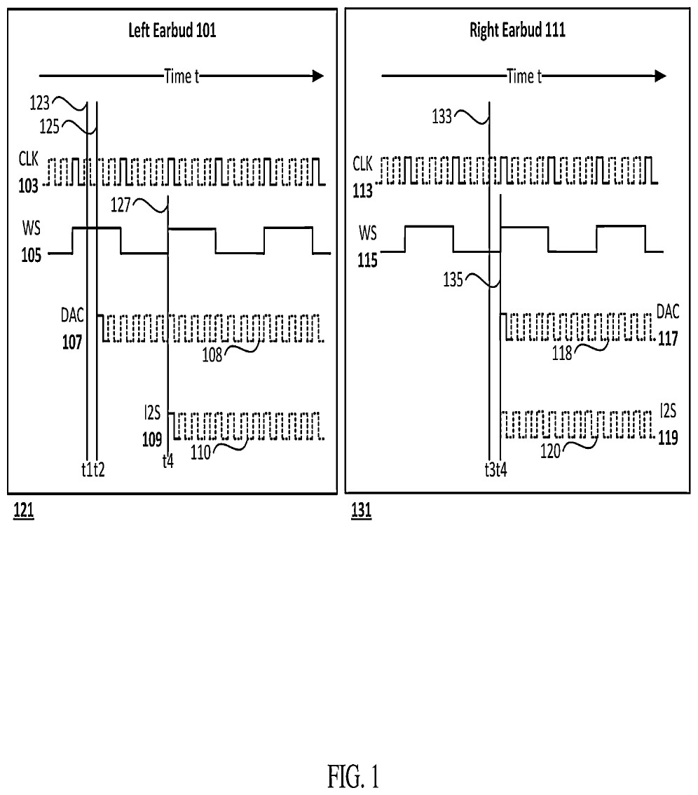

FIG. 1 shows example clocking diagrams 121 and 131 that illustrate an example start-up process for the I2S agents and DACs of audio codec systems in each earbud of a TWS earbud pair. As illustrated in FIG. 1, each of the audio codec systems in the earbuds 101, 111 receive clock signals 103, 113 and WS signals 105, 115 from respective wireless systems in each earbud over a period of time t. That is, a wireless system in the left earbud 101 sends clock signal 103 and WS signal 105, and a wireless system in the right earbud 111 sends clock signal 113 and WS signal 115. For purposes of illustration, the example clocking diagram 100 shows clock signals 103, 113 and WS signal 105, 115 as synchronized, but in many instances, the clock signals may be out of sync, as may the WS signals.

Referring to clocking diagram 121, the audio codec system of the left earbud 101 may receive a command to enable the I2S agent 109 and DAC 107 from the wireless system. In response, the audio codec enables the DAC 107 and I2S agent 109 at time t1, illustrated by line 123. Thus, at the rising edge of the next clock signal 103 at time t2, illustrated by line 125, the DAC 107 starts processing data. The processing of audio samples, which are digital audio samples, by the DAC 107 is illustrated by square wave 108. However, the I2S agent 109 does not start processing data until the next rising edge of the WS 105 at time t4, illustrated by line 127. The processing of digital audio samples by the I2S agent 109 is illustrated by square wave 110. Thus, the DAC 107 begins processing audio samples before I2S agent 109 begins moving audio samples to the DAC 107 (or buffer).

Referring to clocking diagram 131, the audio codec system of the right earbud 111 may receive a command to enable the I2S agent 119 and DAC 117 from the wireless system at time t3, illustrated by line 133. In response to receiving the command, the audio codec enables the DAC 117 and I2S agent 119. The audio codec of the right earbud 111 may receive the command later than the audio codec of the left earbud 101 due to a delay by the wireless system of the right earbud 111 in sending and/or receiving the signal.

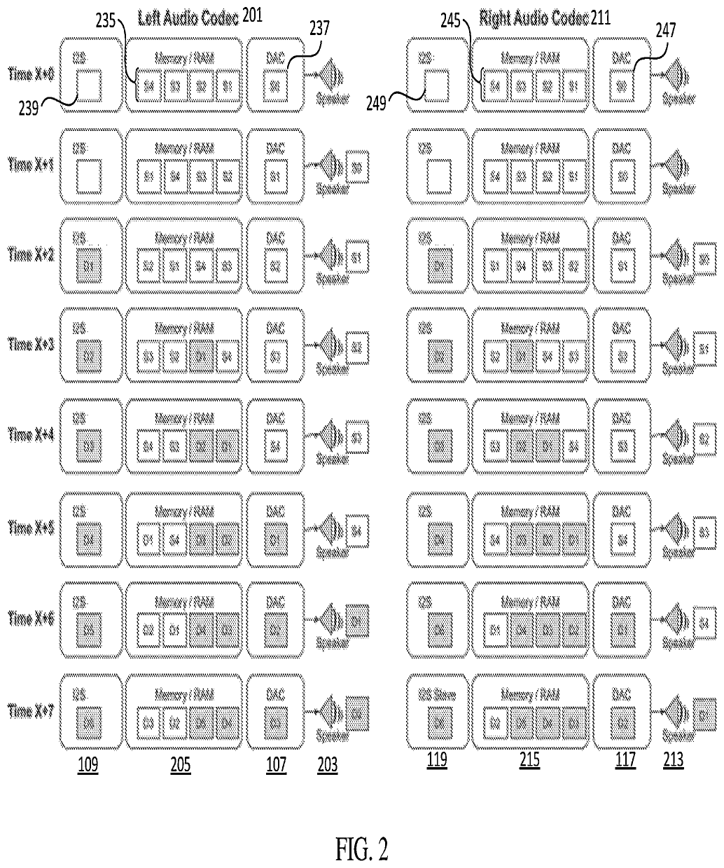

As further illustrated by clocking diagram 131, time t3 is received immediately before a rising edge of the WS signal 115 and a rising edge of clock signal 113, both of which occur at time t4. Thus, it is at time t4 when both the DAC 117 and I2S 119 start. As both the I2S agent 119 and DAC 117 start at the same time (t4), the DAC 117 may begin processing audio samples while I2S agent 119 begins moving audio samples to the DAC 117 (or buffer). It should be noted that the DAC 107 of the left earbud 101 may begin processing and outputting audio samples earlier than the right earbud 111, as explained further with reference to FIG. 2.

FIG. 2 illustrates the flow of data samples into and out of the left audio codec 201 and right audio codec 211 in accordance with the clocking diagrams 121 and 131, respectively. Audio codec 201 includes I2S agent 109, DAC 107, and a memory buffer 205. Audio codec 211 includes I2S agent 119, DAC 117, and a memory buffer 215. DAC 107 and I2S agent 109 each include a single internal buffer location 237 and 239, respectively. Similarly, DAC 117 and I2S agent 119 have a single internal buffer location 247 and 239, respectively. Although each of the DACs and I2S agents is illustrated with a single internal buffer location, each DAC and/or I2S agent may include any number of internal buffer locations. Memory buffers 205 and 215 are shown as including four buffer locations 235, 245, respectively. Although other buffer types may be used, memory buffers 205 and 215 are illustrated as circular buffers. Further, memory buffers 205 and 215 may include any number of buffer locations. For illustration, the buffer locations, including internal buffer locations 237, 239, 247, and 249, as well as the buffer locations 235 and 245 are shown as storing a single audio sample. In practice, buffer locations may store any number of audio samples.

Within FIG. 2, audio samples are either randomized/silence samples, illustrated by ‘S,’ or provided by a wireless system, illustrated by ‘D.’ Audio samples ‘D’ provided by the wireless system that have not yet been played are shaded, whereas audio samples ‘D’ that have been output by a DAC and played are unshaded. Buffer locations without audio samples ‘S’ or ‘D’ are considered empty buffers.

At time X=0, both left and right audio codecs 201, 211 have not yet received an enable command from their corresponding wireless systems (not shown). Thus, buffer 239 of I2S agent 109 and buffer 249 of I2S agent 119 are both empty. The buffer locations 235 and 245 are filled with randomized/silence signals, as illustrated by values S4-S1.

At time X+1, the left Audio Codec receives an enable command from the wireless system of the left earbud (not shown) and, in response, enables the I2S agent 109 and DAC 107. Referring back to clocking diagram 121 in FIG. 1, the I2S agent and DAC are enabled by software two clock pulses after the WS rising edge, and one clock pulse after the enable command is received, illustrated by time t1. As such, the DAC 107 would start on the next clock pulse, at time t2, and also begin to sample data in the memory buffer 205. Thus, the DAC 107 outputs sample S0 for playback through speaker 203, and sample S1 is placed in the internal buffer 237. As the memory buffer 205 is a circular buffer, sample S1 may also be moved back into the last buffer location, previously occupied by S4. At time X+1, the right Audio Codec 211 has not yet received an enable command. Thus the I2S 119 and DAC 117 do not receive, transmit, or otherwise process any data, including audio signals.

At time X+2, the WS rising edge occurs, and the I2S agent 109 of the left audio codec 201 starts receiving the data sent from the wireless system into its internal buffer 239. In this regard, the internal buffer 239 may receive sample D1 from the wireless system. The DAC may process sample S2 within its internal buffer 237 and output sample S1 for playback through speaker 203. Sample S2 may be added back into the last buffer location previously occupied by S1, and S1 may move up one buffer location, as further illustrated in FIG. 2.

Within the right side Audio Codec 211, the software enables the I2S agent 119 and DAC 117 just before the WS rising edge, as illustrated in clocking diagram 131 of FIG. 1. Thus, after the I2S agent 119 and DAC 117 are enabled at the WS rising edge, the I2S agent 119 and DAC 117 would start at the same time or nearly the same time. Accordingly, the I2S agent 119 would start sampling the audio sample sent from the wireless system, D1. The DAC 117 would output the sample previously present in its internal buffer, S0, to the speaker 213, and sample S1 would be put into internal buffer 247 of the DAC 117. Sample S1 would move into the last buffer location, previously occupied by sample S4.

Referring to FIG. 2, at time X+3, sample D1 is moved from internal buffer 239 of I2S agent 109 into the location corresponding to S1 in the buffer location 235 of memory buffer 205. Similarly, sample D1 is moved from internal buffer 239 of I2S agent 109 into the location corresponding to S1 in the buffer location 245 of memory buffer 215. For the I2S agents 109, 119 to receive new samples from the wireless system when their respective internal buffers get filled, the I2S agents 109, 119 move data from their internal buffers into respective memory buffers 205, 215.

During the initialization of the Audio Codecs, software within each Audio Codec may configure the I2S agents or corresponding direct memory access (DMA) engines with the start location in the memory buffer. This location would be used by the I2S agent to move the samples into the memory buffer. In this example, this start location was set up to be the buffer location corresponding to S1, although any location can be selected as the start location. As such, when the I2S agents move samples into the memory buffers, they copy the sample present in their respective internal buffers into the location corresponding to S1 in the internal buffer first, the next sample into the location corresponding to S2, the next sample into the location corresponding to S3, and the next sample into the location corresponding to S4, as illustrated by times X+3 through X+6. This order would then repeat as needed. Although FIG. 2 illustrates the same samples, D1-D4 and ST-S4, within both left Audio Codec 201 and right Audio Codec 211, the samples in the left Audio Code 201 may be different than the samples in the right Audio Codec 211.

Moving the audio samples to the memory buffer from the I2S agent and from the memory buffer from the DAC may be controlled by a DMA engine. The DMA engine may implemented by a processor. The DMA processor may control where audio samples are placed into the memory buffer and which audio samples are removed from the memory buffer. Thus, when the I2S agent and DAC are enabled along with DMA processor, the DMA processor may work in conjunction with the I2S agent and DAC to move the audio samples between the internal buffers and the memory buffer.

In some instances, software, such as software 323 or 333, may include information such as source and destination locations for audio samples. These source and destination locations, which may be programmed into the DMA processor, may include the addresses of the internal buffers and memory buffers. The DMA processor use these addresses to deliver and/or retrieve audio samples from the appropriate buffers.

At time X+6, the DAC 107 of the left Audio Codec 201 outputs sample D1 to the speaker 203. However, the 117 of the right Audio Codec 211 outputs sample S4 to the speaker 213. Thus, the output of the right Audio Codec 211 is lagging behind the output of the left Audio Codec 201 by one sample. Similarly, at time X+7 that DAC 117 of right Audio Codec 211 outputs sample D1 to speaker 213, while DAC 107 of the left Audio Codec 201 outputs sample D2, thereby remaining a sample ahead of DAC 117. A user of the pair of TWS earbuds containing left and right Audio Codecs 201, 211 would begin to hear the left earbud play the audio samples sent by the wireless system first, while the right earbud would lag behind by a sample.

As further illustrated in FIG. 2, the DUT delay of left Audio Codec 201 is five-time periods, from time X+2, when I2S agent 109 receives sample D1 until time X+6, when DAC 107 outputs sample D1 for playback by speaker 203. The DUT delay of right Audio Codec 211 is six-time periods, from time X+2 when I2S agent 119 receives sample D1 until time X+7 when DAC 117 outputs sample D1 for playback by speaker 213. The DUT delays of Audio Codecs 201 and 211 are merely for illustration purposes, and in practice, the DUT delays of Audio Codecs can be more or less. The difference in DUT delays between Audio Codecs may introduce further variations in the timing of playback of audio by the TWS earbuds.

The technology described herein starts the I2S agent and DAC simultaneously to assure a fixed DUT delay. By fixing the DUT delay within the audio codec systems, additional delays introduced by DUT variance may be minimized or otherwise removed. For instance, “I2S WS” detection may be introduced to each audio code within an earbud to control the DAC and I2S agent such that they start sampling or otherwise processing samples at the same time. By doing such, the DUT delay of each audio codec may be consistent every time samples are processed, reducing or otherwise removing the risk of additional DUT delays being introduced. Further, in instances where the characteristics of the components in the audio codec of an earbud are known (e.g., initialization time of the DACs and I2S agents), the DUT delays of different audio codecs may be matched by delaying the enablement command sent to the DACs and I2S agents until a fixed period of time after all of the components are initialized. By doing such, the processing of samples by the audio codecs may be delayed, but differences in output due to DUT delays are removed.

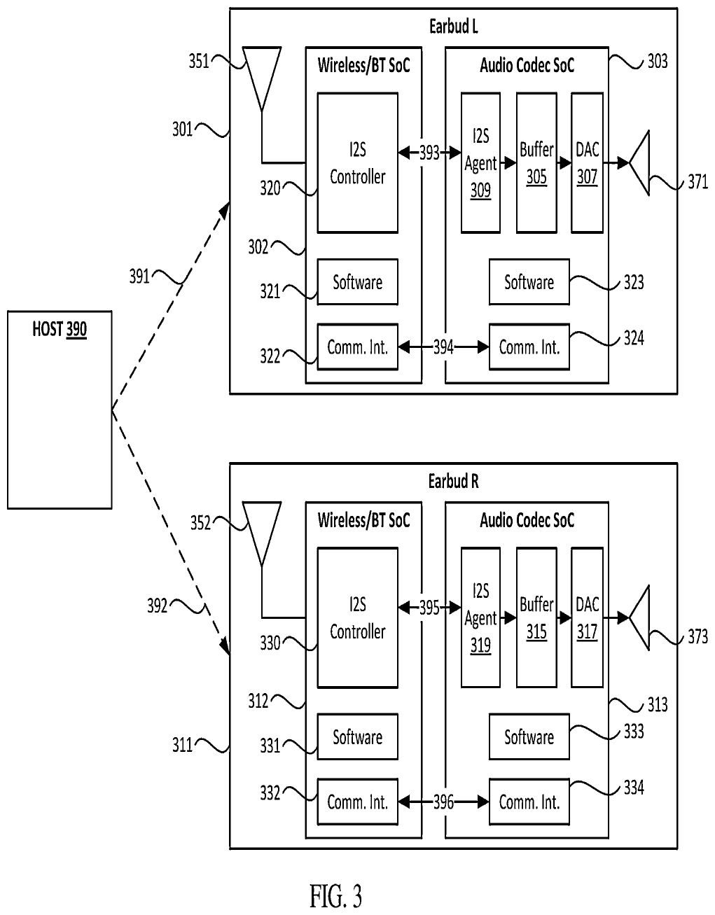

FIG. 3 illustrates an example system in which the I2S WS detection may be implemented. In this regard, FIG. 3 illustrates a host device 390 and a pair of TWS earbuds, including left earbud 301 and right earbud 311. Each earbud includes an antenna 351, 352, a wireless system 302, 312, and an audio codec 303, 313. In operation, the host may send data signals, such as audio samples or control data, to the earbuds 301, 311, as illustrated by dashed lines 391, 392. Antenna 351 may receive signal 391 and forward the data within signal 391 to the wireless system 302. Likewise, antenna 352 may receive signal 392 and forward the data within signal 392 to the wireless system 312. As described in more detail herein, wireless systems 302 and 312 may forward audio samples to audio codecs 303 and 313, respectively. Audio codecs 303 and 313 may process the audio samples and output audio for playback by speakers 371 and 373, respectively.

As further illustrated in FIG. 3, wireless system 302 includes an I2S controller 320, software 321 stored on memory (not shown), and a communication interface 322. Wireless system 312 also includes an I2S controller 330, software 331, and a communication interface 332. Although the wireless systems 302, 312 are illustrated as a system on chip (SoC), the wireless systems may be implemented as discrete components, such as a processor and memory.

Audio codec 303 includes an I2S agent 309, memory buffer 305, DAC 307, software 323 that may be stored on memory (not shown), and a communication interface 324. Similarly, audio codec 313 includes an I2S agent 319, memory buffer 315, DAC 317, software 333 that may be stored on memory (not shown), and a communication interface 334. I2S agents 309 and 319 may be compared to I2S agents 109 and 119, respectively. DACs 307 and 317 may be compared to DACs 107 and 117, respectively. Additionally, memory buffers 305 and 315 may be compared to memory buffers 205 and 215, respectively. Although not shown, audio codecs 303 and 313 may include one or more processors for executing the software 323 and 333, respectively.

Although FIG. 3 illustrates the wireless systems 302, 312, and audio codecs 303, 313 as separate components, the wireless systems and audio codecs may be combined into one component. For instance, wireless system 302 and audio codec 303 may be a single SoC or formed by a processor and memory.

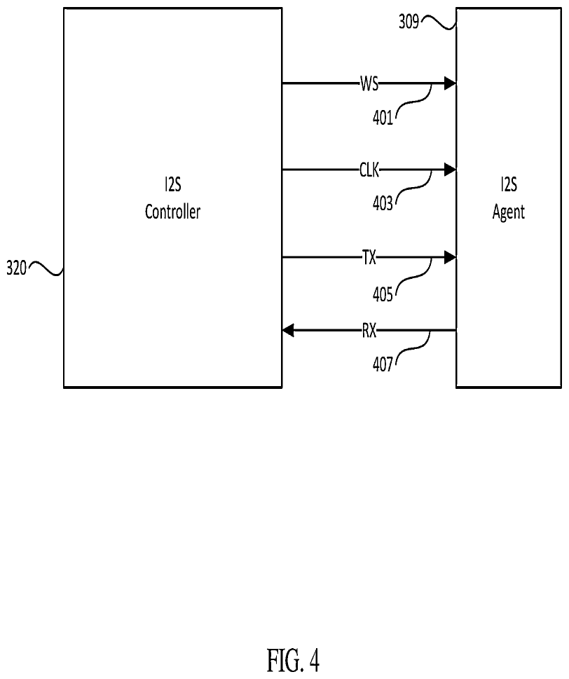

The I2S controllers may communicate with the I2S agents, as illustrated by lines 393 and 395. For instance, and as shown in FIG. 4, I2S controller 320 may provide a word select (WS) signal 401, clock signal 403, and data to I2S agent 309. I2S controller 320 may receive data from the I2S agent 309, as illustrated by line 407. Although not illustrated, I2S controller 330 may provide a WS signal, clock signal, and data to I2S agent 319. I2S controller 330 may also receive data from I2S agent 319.

The communication interface 322 within wireless system 302 may communicate with communication interface 324 in audio codec 303, as illustrated 394. Similarly, communication interface 332 within wireless system 312 may communicate with communication interface 334 in audio codec 313, as illustrated by line 396. The communication interfaces may be interfaces such as another I2C interface, universal asynchronous receiver-transmitter (UART) interfaces, etc. Communications between the communication interfaces may include commands and notifications.

As illustrated in FIG. 3, there is no physical connection between the communication interfaces and the I2S controllers or agents. Software, such as software 321, 331, 323, and 333 may be used to control communication between the communication interfaces and the I2S controller and/or agents. For example, the wireless system 302 may be a Bluetooth system on which software 321 is executed. The software 321 may be configured to prepare and send audio start commands or other such notifications over the communication interface 322 to communication interface 324. Software 323 on audio codec 303 may interpret the commands and notifications received by communication interface 324. The software 323 may then instruct components with the audio codec 303 to take certain actions. For instance, upon receiving the audio start command, the software 323 may send initialization commands to I2S agent 309 and DAC 307.

As previously described, the audio codec system gets a command to enable the I2S agent and DAC from another component within the TWC earbud, such as a wireless system. When the audio codec systems receive the enable commands from the wireless system, the software within the audio codec system enables both the DAC and the I2S agent. For instance, communication interface 322 of the wireless system 302 may send a command to communication interface 324 of the audio codec 303. The software 323 within audio codec 303 may determine the command is to enable I2S agent 309 and DAC 307. However, it is generally not possible for the software of the audio codec system to consistently start the I2S agent 309 and DAC interface 307 together at the same time. The inconsistent start of the I2S agent and DAC is the result of the I2S agent 309 not starting until a rising edge of a WS signal 401, whereas the DAC begins on the next pulse of the clock 403. The rising edge of the WS signal 401 indicates the beginning of the audio sample on the I2S data bus (illustrated by line 393) that connects the I2S controller 320 and the I2S agent 309. As the clock frequency is typically much higher than the frequency of the WS signal 401, the DAC will typically start processing audio samples before the I2S agent starts, causing an unknown DUT delay.

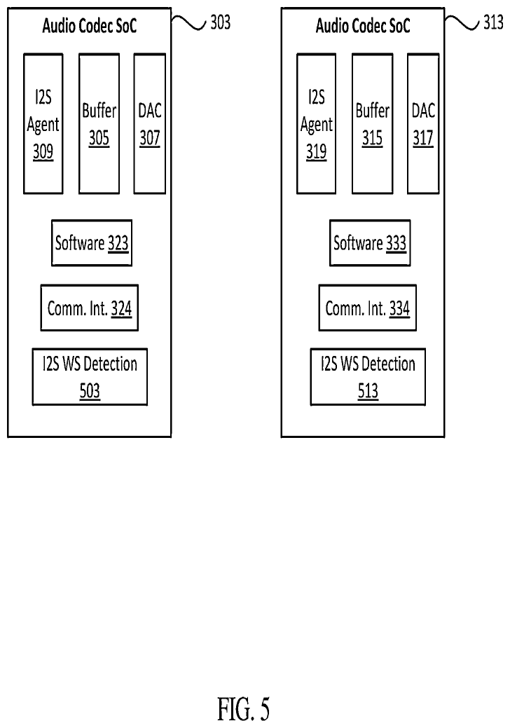

To get a consistent DUT delay by an audio codec, an I2S WS detection component may be used to enable the I2S agent to start at the same time as the DAC. The I2S WS detection component may be a processor or other such IP of the audio codec. FIG. 5 illustrates an I2S WS detection component 503 integrated into audio codec 303 and I2S WS detection component 513 integration into audio codec 313. Each of the I2S WS detection components may be configured to detect the WS rising and falling edges received by the respective audio codecs 303, 313. In this regard, the WS of each audio codec may be provided to the WS detection component of that audio codec. For instance, I2S WS detection component 503 may be configured to receive WS signal 401 and detect the rising and falling edges within the WS signal 401. The I2S WS detection component 503 may then enable the DAC 307 and I2S Agent 309 before the next rising edge of the WS signal 401. Likewise, the I2S WS detection component 513 may be configured to receive the WS signal sent to I2S Agent 319 and detect the rising and falling edges within the WS signal. The I2S WS detection component 513 may then enable the DAC 317 and I2S Agent 319 before the next rising edge of the WS signal.

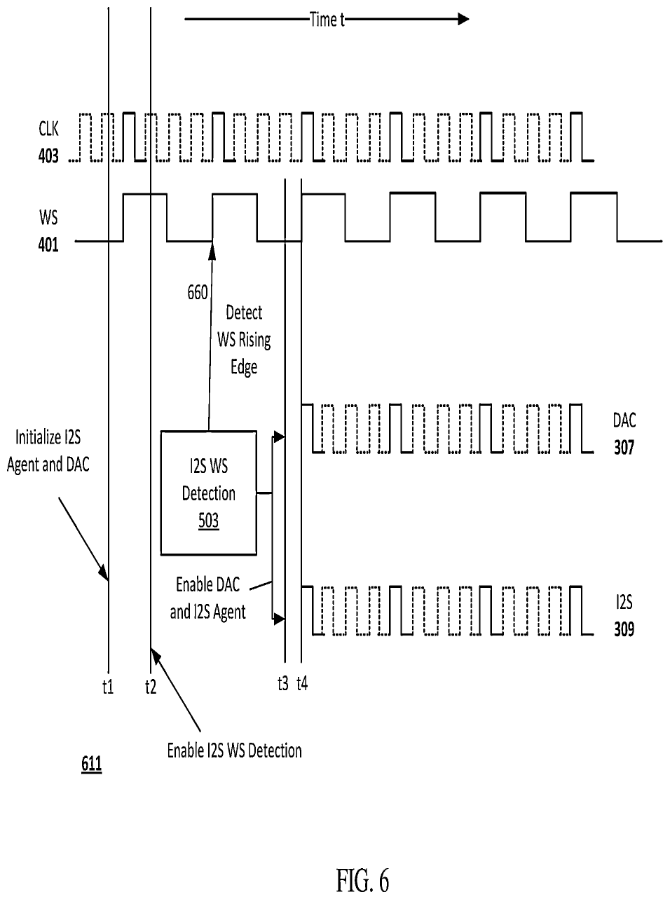

FIG. 6 illustrates an example clocking diagram 611 that illustrates an example start-up process for the I2S agent 309 and DAC 307 of audio codec system 303 with I2S WS detection component 503. At time t1, the software 323 (not shown) of the audio codec 303 may initialize the I2S agent 309 and DAC 307. The initialization process for the I2S agent 309 and DAC 307 may take a few clock cycles. After initializing the I2S agent and DAC, the software 323 may enable the I2S WS detection component 513 at time t2.

As further shown in FIG. 6, after the I2S WS detection component 503 is initialized, the I2S WS detection component 503 monitors the WS signal 401 for a rising edge. Although FIG. 6 illustrates the I2S WS detection component 503 detecting a rising edge of the WS signal 401, the I2S WS detection component may also detect a falling edge of the WS signal.

At time t3, just before the next rising edge of the WS signal 401, after the detected rising edge, identified by arrow 660, the I2S WS detection component may enable both the DAC 307 and I2S agent 309. By enabling the DAC 307 and I2S agent 309 right before the next rising edge of the WS 401 (e.g., at time t3,) both the DAC 307 and I2S agent 309 start processing data at the same time, t4. At time t4, the next rising edge of the WS signal 409 occurs, causing the I2S agent 309 to begin processing. The next clock cycle also happens at time t4, which causes the DAC 307 to begin processing. Thus, both the DAC 307 and I2S agent 309 begin processing data (e.g., audio samples) simultaneously at time t4. The operation of I2S WS detection component 513 within audio codec 313 would be similar to that described herein with regard to I2S WS detection component 503 within audio codec 303.

In some instances, when enabling an I2S agent and DAC simultaneously, initialization delays within the I2S agent and/or DAC may result in either the I2S agent or DAC processing data before the other. For instance, I2S agent 309 may take five clock cycles to initialize, and the DAC 307 may take two clock cycles to initialize. In the event the WS detection component 503 sending an enable command at the fourth clock cycle, the DAC 307 may begin processing data a cycle before the I2S agent.

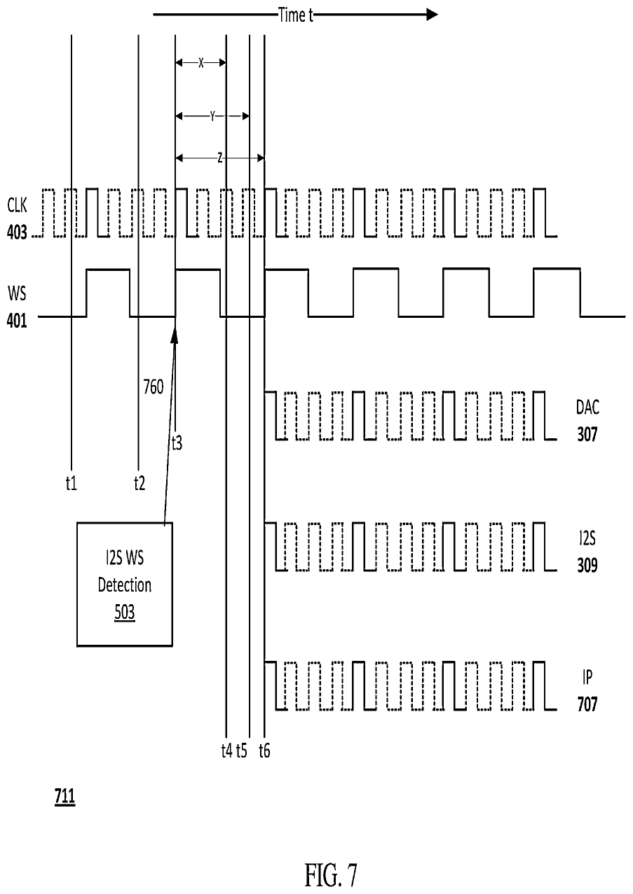

To account for different initialization delays between the I2S agent and DAC, software may be used to control the I2S WS detection component such that it enables the I2S agent and DAC after their respective initialization periods. For instance, and as illustrated in clocking diagram 711 of FIG. 7, the enable commands sent by the I2S WS detection component 503 to the DAC 307, I2S agent 309, and other IP 707 occur at different times (e.g., times t4, t5, and t6, respectively.) As further illustrated in FIG. 7, the time x, which represents the time from t3 to t4, may be predetermined based on the initialization delay of DAC 307. Similarly, time y, which represents the time from t3 to t5, and time z, which represents the time from t3 to t6, may be predetermined based on the known initialization delay of I2S agent 309 and IP 707, respectively. Times x, y, and z may be stored within memory and/or programmed into the software to control when the I2S WS detection component 503 may send an enable command to the DAC 307, I2S agent 309, and other IP 707. Although times x, y, and z are illustrated as occurring before or at the next rising edge of WS 401 after time t3, times x, y, and z may occur after any number of WS clocks.

At time t1, software, such as software 323 may initialize the I2S agent 309 and DAC 307. After initializing the I2S agent 309 and DAC 307, the software 323 may enable the I2S WS detection component 503 at time t2. The time at which the I2S WS detection component 503 is enabled may be random or set to occur at some predetermined period of time after initializing the I2S and/or DAC.

As further shown in FIG. 7, after the I2S WS detection component 503 is initialized, the I2S WS detection component 503 monitors the WS signal 401 for a rising edge. Although FIG. 7 illustrates the I2S WS detection component 503 detecting a rising edge of the WS signal 401 at time t3, the I2S WS detection component may also be configured to detect a falling edge of the WS signal 401.

After detecting the rising edge of the WS signal 401 at time t3, as illustrated by arrow 760, software, such as software 323 or other such software within or associated with I2S WS detection component 503, may instruct the I2S WS detection component 503 to wait for x time before sending an enable command to the DAC 307 at time t4. The software may also instruct the I2S WS detection component 503 to wait for y time before sending an enable command to the I2S agent 309, and waiting z time before sending an enable command to another IP component 707, which may be DMA or other such components. Although only a single IP component 707 is shown, the I2S WS detection component may send enable commands to any number of IP components.

As further shown in FIG. 7, by delaying sending the enable commands to each component (e.g., DAC 307, I2S agent 309, and IP 707), each device starts processing data at the same time.

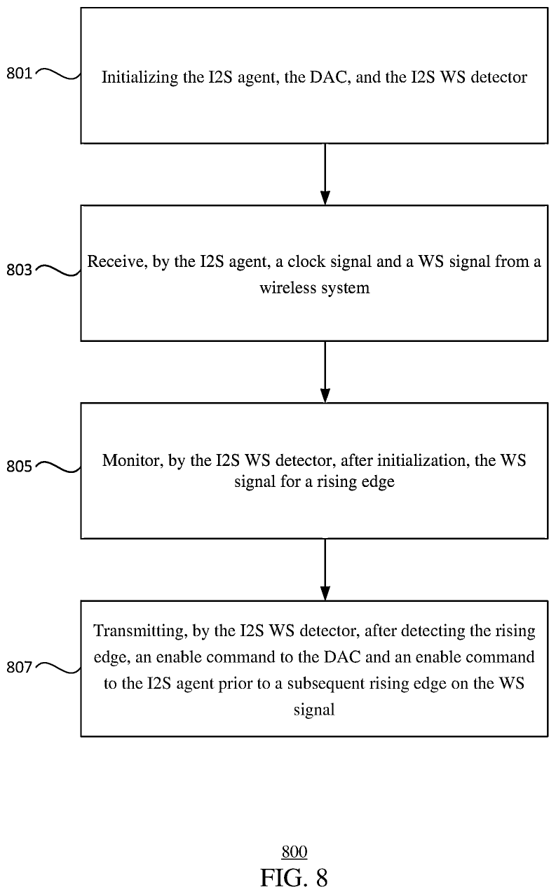

FIG. 8 illustrates a flow diagram 800 for controlling an audio codec, including an inter-IC sound (I2S) agent, a digital-to-analog converter (DAC), and an I2S word-select (WS) detector. As illustrated in block 801, the I2S agent, the DAC, and the I2S WS detector may be initialized. The I2S agent may receive a clock signal and a WS signal from a wireless system, as illustrated in block 803. The I2S WS detector may monitor, after initialization, the WS signal for a rising edge, as illustrated in block 805. After detecting the rising edge, the I2S WS detector may transmit an enable command to the DAC and an enable command to the I2S agent prior to a subsequent rising edge on the WS signal, as illustrated by block 807.

Although the technology is described herein as covering truly wireless earbuds, the technology may also be implemented in other wireless devices where synchronized playback of audio is required. For instance, the technology described herein may be implemented in a pair of wireless speakers, voice assistant devices (e.g., smart speakers), etc. Moreover, the technology may be implemented within more than two devices. For instance, the technology described herein may be implemented in a wireless home theater setup that includes any number of wireless speakers, such as 5.1, 7.1.2, 9.2, etc., wireless speaker configurations.

Unless otherwise stated, the foregoing alternative examples are not mutually exclusive, but may be implemented in various combinations to achieve unique advantages. As these and other variations and combinations of the features discussed above can be utilized without departing from the subject matter defined by the claims, the foregoing description of the embodiments should be taken by way of illustration rather than by way of limitation of the subject matter defined by the claims. In addition, the provision of the examples described herein, as well as clauses phrased as “such as,” “including” and the like, should not be interpreted as limiting the subject matter of the claims to the specific examples; rather, the examples are intended to illustrate only one of many possible embodiments. Further, the same reference numbers in different drawings can identify the same or similar elements.

The invention claimed is:

1. An audio codec comprising:
an inter-IC sound (I2S) agent;
a digital-to-analog converter (DAC); and
an I2S word-select (WS) detector, the I2S WS detector configured to enable the I2S agent and the DAC, such that the DAC and the I2S agent begin processing data simultaneously.

2. The audio codec of claim 1, wherein the I2S agent is configured to receive a clock signal, a WS signal, and the data from a wireless system, where the data includes one or more digital audio samples.

3. The audio codec of claim 2, wherein the I2S agent includes an internal buffer, and the I2S agent is configured to temporarily store the one or more digital audio samples in the internal buffer of the I2S agent.

4. The audio codec of claim 3, further comprising a memory buffer, wherein the I2S agent is configured to transmit the one or more digital audio samples in the internal buffer of the I2S agent to the memory buffer.

5. The audio codec of claim 4, wherein the memory buffer is a circular buffer.

6. The audio codec of claim 4, wherein the DAC includes an internal buffer, and wherein, the DAC is configured to:
receive or retrieve one or more of the digital audio samples from the memory buffer; and
store the one or more of the digital audio samples into the internal buffer of the DAC.

7. The audio codec of claim 6, wherein the DAC is configured to:
convert the one or more of the digital audio samples into analog signals; and
output the analog signals to a speaker for playback.

8. The audio codec of claim 2, further comprising a processor.

9. The audio codec of claim 8, wherein the processor is configured to initialize the I2S agent and the DAC.

10. The audio codec of claim 9, wherein the processor is further configured to, after initializing the I2S agent and the DAC, initialize the I2S WS detector.

11. The audio codec of claim 10, wherein the I2S WS detector is configured to:
after initialization, monitor the WS signal for a rising edge.

12. The audio codec of claim 11, wherein the I2S WS detector is further configured to:
after detecting the rising edge on the WS signal, send an enable command to the I2S agent and the DAC immediately before a subsequent rising edge of the WS signal.

13. The audio codec of claim 11, wherein the I2S WS detector is further configured to:
after detecting the rising edge on the WS signal, wait a first predetermined period of time; and
send an enable command to the I2S agent after the first predetermined period of time.

14. The audio codec of claim 13, wherein the I2S WS detector is further configured to:
after detecting the rising edge on the WS signal, wait a second predetermined period of time; and
send an enable command to the DAC after the second predetermined period of time.

15. A method for controlling an audio codec including an inter-IC sound (I2S) agent, a digital-to-analog converter (DAC), and an I2S word-select (WS) detector, the method comprising:
initializing the I2S agent, the DAC, and the I2S WS detector;
receiving, by the I2S agent, a clock signal and a WS signal from a wireless system;
monitoring, by the I2S WS detector, after initialization, the WS signal for a rising edge; and
after detecting the rising edge, transmitting, by the I2S WS detector, an enable command to the DAC and an enable command to the I2S agent prior to a subsequent rising edge on the WS signal.

16. The method of claim 15, further comprising:
waiting, by the I2S WS detector, a first predetermined period of time after detecting the rising edge on the WS signal; and
sending by the I2S WS detector, the enable command to the I2S agent after the first predetermined period of time.

17. The method of claim 16, further comprising:
waiting, by the I2S WS detector, a second predetermined period of time after detecting the rising edge on the WS signal; and
sending by the I2S WS detector, the enable command to the DAC after the second predetermined period of time.

18. The method of claim 16, further comprising:
receiving, by the I2S agent one or more digital audio samples from the wireless system.

19. The method of claim 18, further comprising:
converting, by the DAC, the one or more digital audio samples received by I2S agent into analog signals for playback.

20. The method of claim 15, wherein the I2S WS detector is initialized after the DAC and the I2S agent.
